(19) United States
(12) Patent Application Publication
(10) Pub. No.: US 2018/0145357 A1
(43) Pub. Date: May 24, 2018

(54) MITIGATION STRATEGIES FOR ENHANCED DURABILITY OF PFSA-BASED SHEET STYLE WATER VAPOR TRANSFER DEVICES

(71) Applicant: GM GLOBAL TECHNOLOGY OPERATIONS LLC, DETROIT, MI (US)

(72) Inventors: FRANK D. COMS, FAIRPORT, NY (US); TIMOTHY J. FULLER, PITTSFORD, NY (US)

(21) Appl. No.: 15/355,474

(22) Filed: Nov. 18, 2016

(51) Int. Cl. H01M 8/0662; H01M 8/04119; H01M 8/04082

(52) U.S. Cl. CPC H01M 8/0662; H01M 8/04149; H01M 2008/1095; H01M 8/04141; H01M 8/04201

(57) ABSTRACT

A membrane humidifier assembly for fuel cell applications includes a first flow field plate adapted to facilitate flow of a first gas thereto, a second flow field plate adapted to facilitate flow of a second gas thereto, and a polymeric membrane disposed between the first flow field plate and second flow field plate. The polymeric membrane is adapted to permit transfer of water. In order to prevent a perfluorosulfonic acid polymer, humidifier membrane from fouling and having diminished water vapor transport performance, ammonia and cation contaminants must be removed from the ambient gas streams. Suitable cationic and ammonia scavengers include filters comprising polymers functionalized with carboxylic acid groups, phosphonic acid groups, sulfonic acid groups, perfluorosulfonic acid groups or combinations thereof.

### TECHNICAL FIELD

In at least one embodiment, the present invention is related to systems for reducing the degradation of fuel cell humidifier membranes.

### BACKGROUND

Fuel cells are used as an electrical power source in many applications. In particular, fuel cells are proposed for use in automobiles to replace internal combustion engines. A commonly used fuel cell design uses a solid polymer electrolyte (“SPE”) membrane or proton exchange membrane (“PEM”) to provide ion transport between the anode and cathode.

In proton exchange membrane type fuel cells, hydrogen is supplied to the anode as fuel and oxygen is supplied to the cathode as the oxidant. The oxygen can either be in pure form (O₂) or air (a mixture of O₂ and N₂). PEM fuel cells typically have a membrane electrode assembly (“MEA”) in which a solid polymer membrane has an anode catalyst on one face, and a cathode catalyst on the opposite face. The anode and cathode layers of a typical PEM fuel cell are formed on porous conductive materials, such as woven graphite, graphitized sheets, or carbon paper to enable the fuel to disperse over the surface of the membrane facing the fuel supply electrode. Each electrode has finely divided catalyst particles (for example, platinum particles), supported on carbon particles, to promote oxidation of hydrogen at the anode and reduction of oxygen at the cathode. Protons flow from the anode through the ionically conductive polymer membrane to the cathode where they combine with oxygen to form water, which is discharged from the cell. The MEA is sandwiched between a pair of porous gas diffusion layers (“GDL”), which in turn are sandwiched between a pair of non-porous, electrically conductive elements or plates. The plates function as current collectors for the anode and the cathode, and contain appropriate channels and openings formed therein for distributing the fuel cell's gaseous reactants over the surface of respective anode and cathode catalysts. In order to produce electricity efficiently, the polymer electrolyte membrane of a PEM fuel cell must be thin, chemically stable, proton transmissive, non-electrically conductive and gas impermeable. In typical applications, fuel cells are provided in arrays of many individual fuel cells arranged in stacks in order to provide high levels of electrical power.

The internal membranes used in fuel cells are typically maintained in a moist condition. This helps avoid damage to, or a shortened life of, the membranes, as well as to maintain the desired efficiency of operation. For example, lower water content of the membrane leads to a higher proton conduction resistance, thus resulting in a higher ohmic voltage loss. The humidification of the feed gases, in particular the cathode inlet, is desirable in order to maintain sufficient water content in the membrane, especially in the inlet region.

To maintain a desired moisture level, an air humidifier is frequently used to humidify the air stream used in the fuel cell. The air humidifier normally consists of a round or box type air humidification module that is installed into a housing of the air humidifier. Membrane humidifiers have also been utilized to fulfill fuel cell humidification requirements. For the automotive fuel cell humidification application, such a membrane humidifier needs to be compact, exhibit low pressure drop, and have high performance characteristics.

Although the current humidifier technology works reasonably well, these humidifiers are subject to performance issues from various environmental contaminants. For example, ammonia present in air degrades the water transfer properties of membranes necessitating the use of somewhat thicker membranes than otherwise necessary.

Accordingly, there is a need for fuel cell humidifier systems that decrease the deleterious effects of ammonia.

### SUMMARY

The present invention solves one or more problems of the prior art by providing in at least one embodiment, a fuel cell system incorporating a membrane humidifier assembly and an ammonia trap is provided. The fuel cell system includes a fuel cell stack having a cathode side and an anode side, a membrane humidifier assembly, and an ammonia trap that receives an oxygen-containing gas from an oxygen-containing gas source, The membrane humidifier includes a first flow field plate adapted to facilitate flow of the input oxygen-containing gas to an input of the cathode side of the fuel cell stack, a second flow field plate adapted to receive a wet exhaust gas from an exhaust of the cathode side of the fuel cell stack, and a polymeric membrane disposed between the first flow field plate and second flow field plate. The polymeric membrane allows the transfer of water from the wet gas to the oxygen-containing gas. The ammonia trap removes ammonia from the input oxygen-containing gas and then provides the input oxygen-containing gas to the fuel cell stack.

In another embodiment, a fuel cell system incorporating a membrane humidifier assembly and an ammonia trap is provided. The fuel cell system includes a fuel cell stack having a cathode side and an anode side, a membrane humidifier assembly, and an ammonia trap that receives input air from an air source. The membrane humidifier includes a first flow field plate adapted to facilitate flow of the input air to an input of the cathode side of the fuel cell stack, a second flow field plate adapted to receive a wet exhaust gas from an exhaust of the cathode side of the fuel cell stack, and a polymeric membrane disposed between the first flow field plate and second flow field plate. The polymeric membrane allows the transfer of water from the wet gas to the input air. The ammonia trap removes ammonia from the input air and then provides the input air to the fuel cell stack. The ammonia trap includes ammonia reactive material. The ammonia reactive material includes polymeric nanofibers that are functionalized with carboxylic acid groups, phosphoric acid groups, sulfonic acid groups, or combinations thereof.

Other exemplary embodiments of the invention will become apparent from the detailed description provided hereinafter. It should be understood that the detailed description and specific examples, while disclosing exemplary embodiments of the invention, are intended for purposes of illustration only and are not intended to limit the scope of the invention.

### BRIEF DESCRIPTION OF THE DRAWINGS

Exemplary embodiments of the present invention will become more fully understood from the detailed description and the accompanying drawings, wherein:

FIG. 1 provides a schematic illustration of a fuel cell that can be used in conjunction with a fuel cell humidifier;

FIG. 2 is a schematic of a fuel cell system including a membrane humidifier assembly for humidifying a cathode inlet airflow to a fuel cell stack;

FIG. 3 is a schematic cross section of a membrane humidifier assembly perpendicular to the flow of gas to a first flow field plate; and

FIG. 4 is a schematic cross section of an ammonia trap.

### DETAILED DESCRIPTION

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

Throughout this application, where publications are referenced, the disclosures of these publications in their entireties are hereby incorporated by reference into this application to more fully describe the state of the art to which this invention pertains.

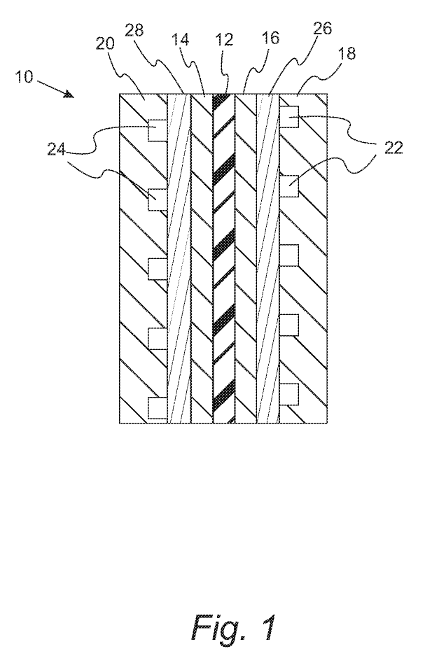

With reference to FIG. 1, a schematic cross section of a fuel cell is provided. Proton exchange membrane (PEM) fuel cell 10 includes polymeric ion conducting membrane 12 disposed between cathode catalyst layer 14 and anode catalyst layer 16. Advantageously, the membrane 12 and/or the electrode catalyst layers 14 and 16 include ionomer fibers made by a variation of the processes set forth below. Fuel cell 10 also includes flow field electrically conductive plates 18, 20, gas channels 22 and 24, and gas diffusion layers 26 and 28. Diffusion layers 26 and 28 are typically electrically conductive, porous, carbon fiber papers. During operation of the fuel cell 10, a fuel such as hydrogen is feed to the flow field plate 18 on the anode side and an oxidant such as oxygen is feed to the flow field plate 20 on the cathode side. Hydrogen ions are generated by anode catalyst layer 16 migrate through polymeric ion conducting membrane 12 where they react at cathode catalyst layer 14 to form water. This electrochemical process generates an electric current through a load connect to flow field plates 18 and 20.

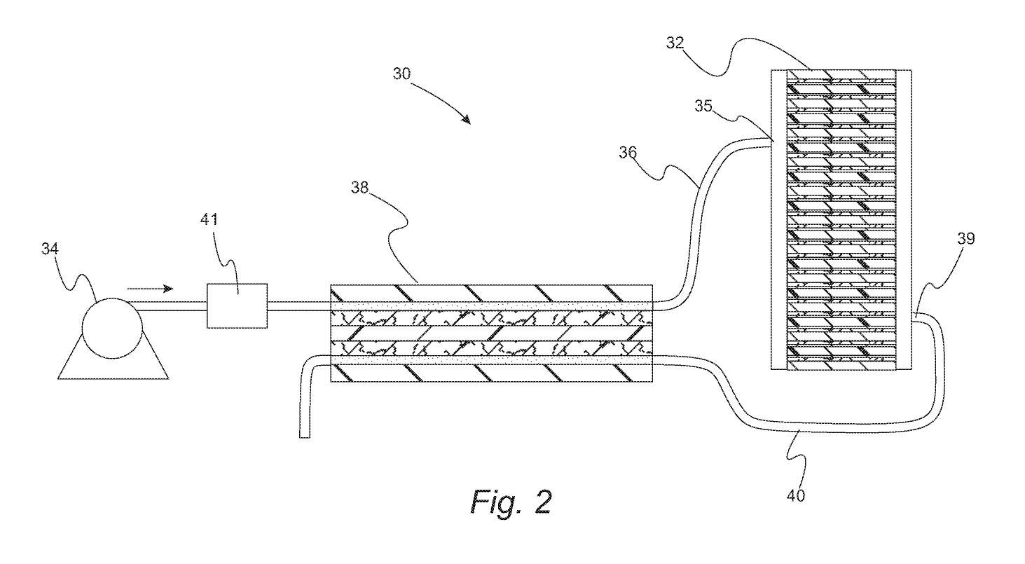

With reference to FIG. 2, a schematic of a fuel cell system incorporating a membrane humidifier assembly is provided. Fuel cell system 30 includes fuel cell stack 32. Oxygen containing gas source 34 (e.g., a compressor) provides a flow of oxygen-containing gas (e.g., air) to input 35 on the cathode side of the fuel cell stack 32 on a cathode input line 36. The flow of oxygen-containing gas from the oxygen-containing gas source 34 is sent through membrane humidifier assembly 38 to be humidified. A cathode exhaust gas is output from exhaust 39 of the fuel cell stack 32 on a cathode output line 40. The cathode exhaust gas includes a considerable amount of water vapor and/or liquid water as a by-product of the electrochemical process in the fuel cell stack 32. As is well understood in the art, the cathode exhaust gas can be sent to membrane humidifier assembly 38 to provide the humidification for the cathode inlet air on the line 36. Fuel cell system 30 also includes ammonia trap 41 that removes ammonia from the input oxygen-containing gas and then provides the input oxygen-containing gas to the fuel cell stack.

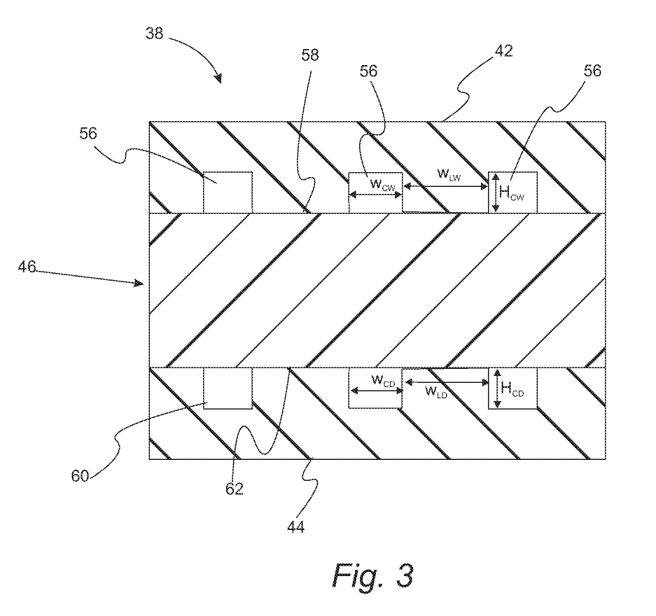

With reference to FIG. 3, a schematic cross section of a membrane humidifier assembly is provided. The membrane humidifier of this embodiment may be used in any application in which it is desirable to transfer water from a wet gas (e.g., air) to a dry gas (e.g., air) such as the fuel cell system of FIG. 2. Membrane humidifier assembly 38 includes first flow field plate 42 adapted to facilitate flow of a first gas to membrane humidifier assembly 38. Membrane humidifier assembly 38 also includes second flow field plate 44 adapted to facilitate flow of a second gas to membrane humidifier assembly 38. In a refinement, first flow field plate 42 is a wet plate and second flow field plate 44 is a dry plate. Polymeric membrane 46 is disposed between the first flow field plate 42 and second flow field plate 44. In one variation, polymeric membrane 46 includes one or more perfluorosulfonic acid polymer (PFSA) layers. Advantageously, the utilization of an ammonia trap allows thin PFSA membranes of high water permeance to be used for polymeric membrane 46. Thin membranes will also reduce device cost. In a refinement, polymeric membrane 46 has a thickness from about 5 to 50 microns. In a further refinement, polymeric membrane 46 has a thickness from about 0.5 to 10 microns.

First flow field plate 42 includes a plurality of flow channels 56 formed therein. The channels 56 are adapted to convey a wet gas from the cathode of the fuel cell to an exhaust (not shown). In a refinement of the present embodiment, channels 56 are characterized by a width W_{CW} and a depth H_{CW}. A land 58 is formed between adjacent channels 56 in flow field plate 42. The land 58 includes a width W_{LW}. It should be appreciated that any conventional material can be used to form the first flow field plate 42. Examples of useful materials include, but are not limited to, steel, polymers, and composite materials, for example. Second flow field plate 44 includes a plurality of flow channels 60 formed therein. The channels 60 are adapted to convey a dry gas from a source of gas (not shown) to the cathode of the fuel cell. As used herein, wet gas means a gas such as air and gas mixtures of O₂, N₂, H₂O, H_{z}, and combinations thereof, for example, that includes water vapor and/or liquid water therein at a level above that of the dry gas. Dry gas means a gas such as air and gas mixtures of O₂, N₂, H₂O, and H₂, and combinations thereof, for example, absent water vapor or including water vapor and/or liquid water therein at a level below that of the wet gas. It is understood that other gases or mixtures of gases can be used as desired. Channels 60 include a width W_{CD} and a depth H_{CD}. A land 62 is formed between adjacent channels 60 in second flow field plate 44. The land 62 includes a width W_{LD}. It should be appreciated that any conventional material can be used to form the field plate 44 such as steel, polymers, and composite materials, for example.

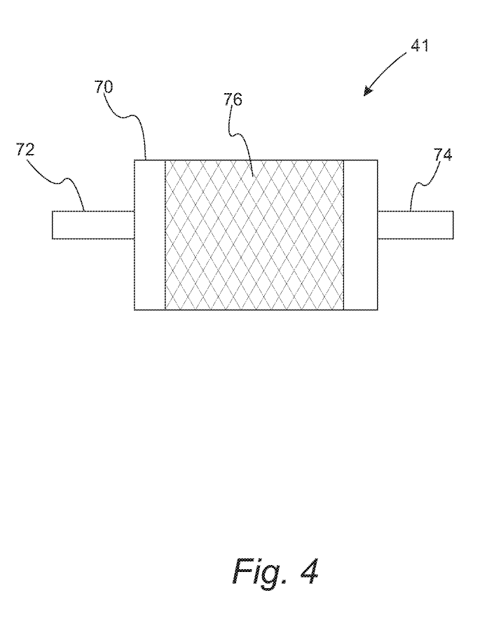

With reference to FIG. 4, ammonia trap is schematically illustrated. Ammonia trap 41 includes enclosure 70 with input port 72 and output port 74. Enclosure 70 holds ammonia reactive material 76 that adsorbs, reacts with, or otherwise traps ammonia from input air. In one variation, ammonia reactive material 76 includes acid groups that can react with ammonia via an acid base reaction. In a further refinement, ammonia reactive material 76 includes an acid (e.g., phosphoric acid) that can be impregnated on a substrate such as a filter (e.g., nadp.sws.uiuc.edu/AMoN/fieldMethods.aspx). Particularly useful materials that react with ammonia include polymer functionalized with acids groups, and in particular, functionalized with carboxylic acid groups, phosphonic acid groups, sulfonic acid groups, and combinations thereof. Examples of polymers functionalized with carboxylic acid groups include, but are not limited to, poly(acrylic acid) (MW 2,000-4,000,000), poly(butadiene/maleic acid) 1:1 (molar) (MW 12,000), poly(n-butyl acrylate/acrylic acid) [50:50], poly(ethyl acrylate/acrylic acid) [50:50], poly(ethylene/acrylic acid), poly(ethylene/maleic anhydride) 1:1 (molar) (MW 400,000), poly(maleic acid) (MW 1,000), poly(methacrylic acid) (MW 100,000), poly(methacrylic acid) ammonium salt (MW 15,000), poly(methyl methacrylate/methacrylic acid) [90:10] (MW 100,000), poly(methyl methacrylate/methacrylic acid), poly(methyl methacrylate/methacrylic acid) [75:25] (MW 1,200,000), poly(methyl methacrylate/methacrylic acid) [80:20], poly(styrenesulfonic acid/maleic acid) (MW 20,000), poly(vinyl chloride/vinyl acetate/maleic acid), and combinations thereof. Examples of polymers functionalized with phosphonic acid groups include, but are not limited to, poly(vinyl phosphonic acid) (MW >200,000) and perfluorophosphonic acid polymer. Examples of sulfonic acid polymers include, but are not limited to, poly(styrenesulfonic acid) and perfluorosulfonic acid polymers (PFSA) (MW 10⁵-10⁶ Da). In other variations, the ammonia reactive material includes compounds and polymer functionalized with ester groups, aldehyde groups, or ketone groups. Moreover, commercial cross-linked resins such as Dowex and Amberlite with acid functionalities can also be used. Perfluorocyclobutane polymers with sulfonic acid, phosphonic acid, and perfluorosulfonic acid functionalities can also be used.

In one particularly useful variation, ammonia reactive material 76 is in the form of polymeric nanofibers. In this variation, each of the acid functionalized polymers set forth above can be used in nanofiber form. In a refinement, the polymeric nanofibers have an average width from about 50 nanometers to about 100 nanometers. In a further refinement, the polymeric nanofibers have a length from 1 mm to 100 mm or more. U.S. patent application Ser. No. 15/219,783 provides particularly useful nanofibers based on PFSA polymers; the entire disclosure of this application is hereby incorporated by reference. In this regard, the ammonia reactive material and in particular, useful nanofibers have the following formulae I, II, or III:

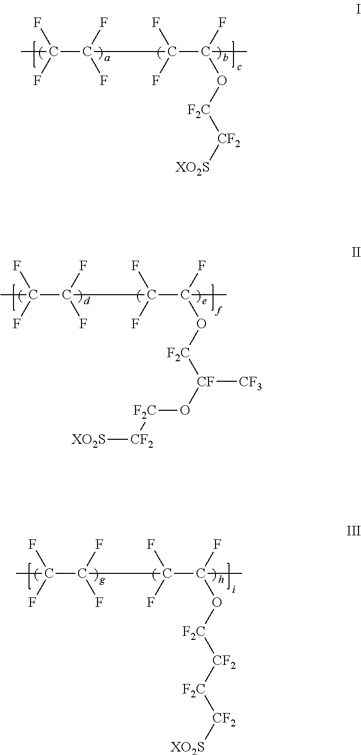

wherein:

a is about 5 or 6;

b is 1;

c is on average from about 30 to 150;

d is about 5;

e is 1;

f is on average from about 30 to 150;

g is about 5;

h is 1;

i is on average from about 30 to 150; and

X is OH or F.

The following examples illustrate the various embodiments of the present invention. Those skilled in the art will recognize many variations that are within the spirit of the present invention and scope of the claims. These examples are from U.S. patent application Ser. No. 15/219,783; the entire disclosure of which is hereby incorporated by reference.

Preparation of Nanofibers of Poly[perfluoro(4-methyl-3,6-dioxaoct-7-ene)sulfonic acid-tetrafluoroethylene].

Nafion R1000® (5 grams, sulfonyl fluoride form) is mixed with a 200,000-molecular weight (Dalton), water soluble polymer poly(2-ethyl-2-oxazoline) (PEOX, 15 g, Alfa). The combined blend is then added to a laboratory mixing extruder (Dynisco, LME) operated at 200 degree C. header and rotor temperatures with the drive motor operated at 50% of capacity, resulting in an extruded strand of the blend. This extruded strand is added to a blender to return it to granular form, and is then re-extruded two more times, creating a uniform extruded strand. During the final extrusion process, the fibers are spun onto a take-up wheel (a Dynisco Take-Up System, TUS), at approximately 10 cm/second. The resulting extruded strand is added to water (400 mL) using a Waring blender, until the PEOX dissolves. Nafion R1000® nanofibers (in the sulfonyl fluoride form) are collected as a sediment after centrifugation, and then are repeatedly washed in water using a Waring blender followed by centrifugation until the PEOX is removed. After centrifugation, the sediment consisting of Nafion R1000® nanofibers (in the sulfonyl fluoride form) is stirred with 25 wt. % sodium hydroxide (200 mL) for 16 hours, and then is centrifuged. The sediment is repeatedly washed with water and centrifuged to remove the NaOH. The nanofiber sediment is then stirred with 18 wt. % hydrochloric acid in water (200 mL) for 16 hours. The nanofibers are collected as a sediment after centrifugation. The nanofiber sediment is purified by extensive washings and centrifugations with deionized water, and then is collected by filtration and dried. Typically, the nanofibers are approximately 0.5 to 1 micron wide and more than 10 micron long, and are in the perfluorosulfonic acid ionomer form.

Preparation of Gas Filters with Perfluorosulfonic Acid (PFSA) Nanofibers.

A polyethylene drying tube with polypropylene tube fittings (Bel-Art SP Scienceware, 7.39-in long, 16-mm inner diameter, and 19-mm outer diameter available from Fisher Scientific) is packed with a plug consisting of a small wad of glass wool, then a long bed of perfluorosulfonic acid nanofibers, and then another plug consisting of a small wad of glass wool. Cotton wads can also be used instead of the glass wool. This tube serves as a filter to remove ammonia and cationic impurities from ambient air streams fed to flat sheet PFSA, water vapor transfer (WVT) humidifiers that humidify gases to fuel cells. Flat sheet WVT humidifiers made with PFSA ionomers are easily poisoned by cationic and amine impurities, which are effectively removed by these PFSA nanofiber gas filters.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A fuel cell system comprising:
a fuel cell stack having a cathode side and an anode side;
a membrane humidifier assembly comprising:
a first flow field plate providing an input oxygen-containing gas to an input on the cathode side of the fuel cell stack;
a second flow field plate adapted to receive a wet gas from an exhaust of the cathode side of the fuel cell stack; and
a polymeric membrane disposed between the first flow field plate and second flow field plate, the polymeric membrane allowing transfer of water from the wet gas to the input oxygen-containing gas; and
an ammonia trap that receives oxygen-containing gas from an oxygen-containing gas source, the ammonia trap removing ammonia from the input oxygen-containing gas and then providing the oxygen-containing gas to the fuel cell stack.

2. The fuel cell system of claim 1 wherein the ammonia trap includes an ammonia reactive material.

3. The fuel cell system of claim 2 wherein the ammonia reactive material includes acid groups that can react with ammonia via an acid base reaction.

4. The fuel cell system of claim 2 wherein the ammonia reactive material includes a phosphoric acid impregnated on a substrate.

5. The fuel cell system of claim 2 wherein the ammonia reactive material includes a polymer functionalized with acid groups.

6. The fuel cell system of claim 2 wherein the ammonia reactive material includes a polymer functionalized with carboxylic acid groups, phosphonic acid groups, sulfonic acid groups, or combinations thereof.

7. The fuel cell system of claim 2 wherein the ammonia reactive material includes a polymer functionalized with carboxylic acid groups selected from the group consisting of poly(acrylic acid), poly(butadiene/maleic acid), poly(n-butyl acrylate/acrylic acid), poly(ethyl acrylate/acrylic acid), poly(ethylene/acrylic acid), poly(ethylene/maleic anhydride), poly(maleic acid), poly(methacrylic acid), poly(methacrylic acid) ammonium salt, poly(methyl methacrylate/methacrylic acid), poly(methyl methacrylate/methacrylic acid), poly(methyl methacrylate/methacrylic acid), poly(methyl methacrylate/methacrylic acid), poly(styrenesulfonic acid/maleic acid)poly(vinyl chloride/vinyl acetate/maleic acid), Dowex with acid groups, Amberlite with acid groups, perfluorocyclobutane polymers with acid groups, and combinations thereof.

8. The fuel cell system of claim 2 wherein the ammonia reactive material includes a functionalized with phosphonic acid groups selected from the group consisting of poly(vinyl phosphonic acid), perfluorophosphonic acid polymer, perfluorocyclobutane polymers with phosphonic acid groups, crosslinked polystyrene with phosphonic acid groups, and combinations thereof.

9. The fuel cell system of claim 2 wherein the ammonia reactive material includes a functionalized sulfonic acid groups selected from the group consisting of poly(styrenesulfonic acid), perfluorosulfonic acid polymers, Dowex and Amberlite with sulfonic acid groups, perfluorocyclobutane polymers with sulfonic and perfluorosulfonic acid groups, and combinations thereof.

10. The fuel cell system of claim 2 wherein the ammonia reactive material includes polymeric nanofibers.

11. The fuel cell system of claim 10 wherein the ammonia reactive material includes a polymer having formula I: 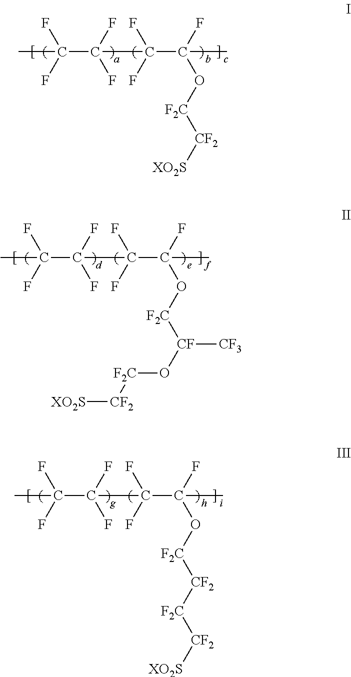
wherein:
a is about 5 or 6;
b is 1;
c is on average from about 30 to 150;
and
X is OH or F.

12. The fuel cell system of claim 10 wherein the ammonia reactive material includes a polymer having formula II: 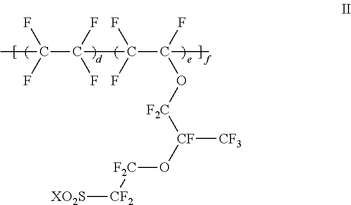
wherein:
d is about 5;
e is 1;
f is on average from about 30 to 150; and
X is OH or F.

13. The fuel cell system of claim 10 wherein the ammonia reactive material includes a polymer having formula III: 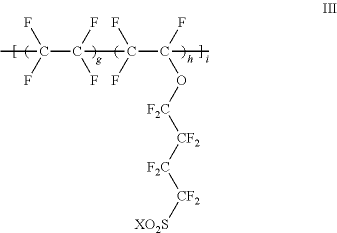
wherein:
g is about 5;
h is 1;
i is on average from about 30 to 150; and
X is OH or F.

14. A fuel cell system comprising:
a fuel cell stack having a cathode side and an anode side;
a membrane humidifier assembly comprising:
a first flow field plate providing an input air to an input on the cathode side of the fuel cell stack;
a second flow field plate adapted to receive a wet gas from an exhaust of the cathode side of the fuel cell stack; and
a polymeric membrane disposed between the first flow field plate and second flow field plate, the polymeric membrane allowing transfer of water from the wet gas to the input air; and
an ammonia trap that receives air from an air source, the ammonia trap removing ammonia from the input air and then providing the air to the fuel cell stack, wherein the ammonia trap removing ammonia contains ammonia reactive material that includes polymeric nanofibers that are functionalized with carboxylic acid groups, phosphonic acid groups, sulfonic acid groups, perfluorosulfonic acid groups, or combinations thereof.

15. The fuel cell system of claim 14 wherein the ammonia reactive material includes a polymer functionalized with carboxylic acid groups selected from the group consisting of poly(acrylic acid), poly(butadiene/maleic acid), poly(n-butyl acrylate/acrylic acid), poly(ethyl acrylate/acrylic acid), poly(ethylene/acrylic acid), poly(ethylene/maleic anhydride), poly(maleic acid), poly(methacrylic acid), poly(methacrylic acid) ammonium salt, poly(methyl methacrylate/methacrylic acid), poly(methyl methacrylate/methacrylic acid), poly(methyl methacrylate/methacrylic acid), poly(methyl methacrylate/methacrylic acid), poly(styrenesulfonic acid/maleic acid)poly(vinyl chloride/vinyl acetate/maleic acid), Dowex and Amberlite with acid groups, and combinations thereof.

16. The fuel cell system of claim 14 wherein the ammonia reactive material includes a functionalized with phosphonic acid groups selected from the group consisting of poly(vinyl phosphonic acid), perfluorophosphonic acid polymer, perfluorocyclobutane polymers with phosphonic acid groups, crosslinked polystyrene resins with phosphonic acid groups, and combinations thereof.

17. The fuel cell system of claim 14 wherein the ammonia reactive material includes a functionalized sulfonic acid groups selected from the group consisting of poly(styrenesulfonic acid), perfluorosulfonic acid polymers, Dowex and Amberlite with sulfonic acid groups, perfluorocyclobutane polymers with sulfonic acid and perfluorosulfonic acid groups, and combinations thereof.

18. The fuel cell system of claim 14 wherein the ammonia reactive material includes a polymer having formula I: 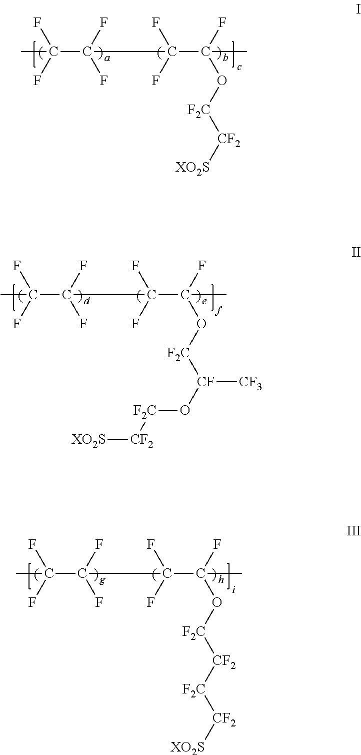
wherein:
a is about 5 or 6;
b is 1;
c is on average from about 30 to 150;
and
X is OH or F.

19. The fuel cell system of claim 14 wherein the ammonia reactive material includes a polymer having formula II: 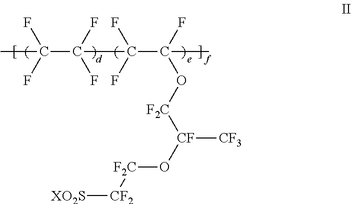
wherein:
d is about 5;
e is 1;
f is on average from about 30 to 150; and
X is OH or F.

20. The fuel cell system of claim 14 wherein the ammonia reactive material includes a polymer having formula III: 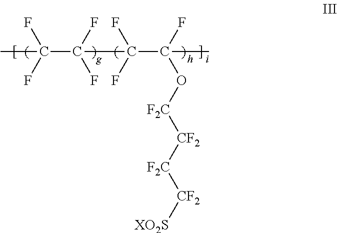
wherein:
g is about 5;
h is 1;
i is on average from about 30 to 150; and
X is OH or F.
